(19) United States
(12) Patent Application Publication
(10) Pub. No.: US 2002/0176403 A1
(43) Pub. Date: Nov. 28, 2002

(54) Method and system for communicating voice over IP access networks

(76) Inventor: Eytan Radian, Dallas, TX (US)

Correspondence Address: Edward Langer, Pat. Atty., c/o Landon & Stark Associates, One Crystal Park, Suite 210, 2011 Crystal Drive, Arlington, VA, 22202, US

(21) Appl. No.: 10/101,571

(22) Filed: Mar. 20, 2002

Related U.S. Application Data
(60) Provisional application No. 60/276,926, filed on Mar. 20, 2001.

(51) Int. Cl. H04L 12/28; H04J 3/12

(52) U.S. Cl. 370/352; 370/524; 370/401

(57) ABSTRACT

A system and a method for a voice gateway to deliver voice over Internet Protocol (VoIP) via an electronic network for digital data signals comprising IP packets. The system and method operate by transferring and converting voice streams from a Public Switched Telephone Network (PSTN) into IP packets for delivery to a customer premises inter-working (CP-IWF) device via a data port, which is interfaced to customer premises equipment (CPE), wherein the CP-IWF device serves as a gateway between the digital data signals used in the electronic network and the PSTN voice streams. The system includes an access gateway, including a V5.x device for interfacing the electronic network to the PSTN. The system also includes a voice gateway to deliver voice over Internet protocol (VoIP) and a Call Agent to keep track of the calling state between said CP-IWF device and said voice gateway, such that the voice streams are converted from the PSDN/Integrated Services Digital Network (ISDN) into IP packets.

### FIELD OF THE INVENTION

The present invention relates generally to telecommunications, and in particular, the invention relates to the transporting of voice and Integrated Systems Digital Networks (ISDN) over broadband Next Generation Access (NGA) networks between customer premises and the Public Switch Telephone Network (PSTN).

### BACKGROUND OF THE INVENTION

The following trends represent a driving force towards dramatic change in the global telecommunications industry: (1) deregulation; and (2) Increased competition and consolidation.

For more than 100 years the telecommunications industry has been heavily regulated. incumbent service providers, such as the regional Bell operating companies in the United States and state-owned telecommunications monopolies in European countries, enjoyed a protected monopoly in several sectors of the industry, including voice services. However, the Telecommunications Act of 1996 In the United States, a series of European Union directives in Europe and international agreements such as the World Trade Organization agreement of 1997, have resulted in deregulation of the telecommunications Industry. Deregulation has created competition between the former monopolistic, incumbent service providers, and now or emerging service providers such as Competitive Local Exchange Carriers (CLECs), cable television (TV) operators, Internet service providers and satellite communications companies. As a result these service providers are competing for all telecommunications services, including voice, video and data. For example, cable TV operators are now offering voice services in addition to cable TV services.

Most recently, regulators have focused on promoting competition in the segment connecting customers to service providers' central offices, also referred to as the local loop or the access network. In many countries, regulators are encouraging, and in some cases requiring, incumbent service providers to separate voice services from the other services they provide, also known as unbundling, to allow customers to choose separate service providers for different services,

These regulators are also encouraging or requiring incumbent service providers to allow emerging service providers to locate their equipment at the incumbent service providers' central offices, also known as colocation. Additionally, increased competition has led to consolidation within the telecommunications industry, as service providers seek to broaden their service offerings and geographic reach, reduce costs and differentiate themselves from their competitors.

Deregulation, increased competition and growth in date traffic are causing significant changes in the architecture of telecommunications networks. A telecommunications network can generally be divided into voice and data backbones, central offices, access networks and customer-premises equipment (CPE), such as telephones, fax machines and computers.

The PSTN-voice backbone and data backbone networks comprise high bandwidth fiber optic links, switches, routers and transmission equipment Service providers have made, and are continuing to make, significant investments In backbone networks to increase the capacity and bandwidth of existing networks and to create new networks.

Traditionally, two separate backbones carried voice and data traffic: public switched telephone networks carried voice and data networks carried data. Although some service providers are seeking to converge the two backbone networks into one backbone network capable of carrying both data and voice traffic, other service providers, particularly incumbent service providers, continue to invest and maintain separate voice and data backbones.

Central offices connect backbone networks and access networks. Central offices host voice switches that switch incoming and outgoing voice calls to their ultimate destination, and host routers and data switches that handle data traffic. Service providers using class 5 switches, a type of voice switch typically installed at central offices, offer their customers a variety of value-added services, such as call forwarding, call waiting and caller Identification. Historically, incumbent service providers owned and operated central offices.

Access networks comprise access lines and equipment connecting service providers' central offices to CPE's and Integrated Access Devices (IAD's)/Media Terminal Adapters (MTAs), which connect several CPE's. The access equipment communicates with central office equipment using a variety of signaling systems, or protocols, which regulate the exchange of information between PSTN switches and access equipment, For example, V5.2 is a non-proprietary, open protocol that PSTN switches and access equipment use to communicate with one another, and Is the standard protocol outside the United States and Canada, Other open protocols include GR-303, which is the new North American access protocol. The V5.2 standard specifies an open interface for access network systems. With concentration and protection features, the V5 standard was approved by the European Telecommunications Standards Institute (ETSI) and the International Telecommunications Union (ITU) and adopted by European, Asian, Australian and Latin America carriers for PSTN, integrated services digital networks (ISDN) and leased lines.

Bottlenecks in networks occur where the capacity, or bandwidth, of a network segment is not sufficient to effectively handle the volume of telecommunications traffic. As a result of recent investments made to increase the capacity of backbone networks and accommodate the growth in data traffic, the bottleneck in the network has shifted to the access network, due to the bandwidth limitations of twisted pair copper wire access lines. Prior to the development of Next Generation Access (NGA) technologies, copper lines supported only low-bandwidth traffic such as analog voice or data transmissions with speeds up to 64 kilobits per second (kbps), for dial-up modems, and speeds of up to a maximum of 128 kbps for ISDN lines. To cost-effectively overcome the limitations of the existing copper lines, service providers have been deploying new technologies and access networks that enable them to deliver high-bandwidth, or broadband, communications services to their subscribers.

The access bottleneck can be addressed by NGA methods either by enhancing the bandwidth available on existing copper lines or by providing services over alternative access networks such as cable TV or broadband wireless networks.

The following technologies address the bottleneck:

Digital Subscriber Lines (xDSL) is a generic name for a set of technologies designed to increase bandwidth over existing copper lines using sophisticated digital signal processing techniques;

Cable TV Technologies comprise TV networks, consisting of fiber optic cables and coaxial cables connected to the customers' premises, and were deployed by cable TV companies to carry one-way analog television. Cable data and telephone modern technologies have been developed to carry other types of transmissions, including voice or data, over the cable network, taking advantage of cables superior bandwidth; and

Broadband Wireless Technologies connect subscribers to central offices through radio signals transmitted to and from fixed radio transmitters installed at the customers' premises and at radio base stations. A base station aggregates voice and data transmissions from several subscribers, and transmits them to a central office.

The PSTN Access Gateway provides connectivity from the following NGA Equipment:

digital subscriber line access multiplexer (DSLAM) for copper infrastructure;

HFC Headend for Cable infrastructure; and

a Wireless Base Station for Wireless infrastructure or asynchronous transfer mode switch/Internet protocol (ATM/IP) router to the Class 5 PSTN switch.

The PSTN Access Gateway serves as the bridge between the circuit-based voice switch and the packet-based data network. It receives voice traffic in an IP packet format, converts to standard time division multiplexing (TDM) pulse-coded modulation PCM format and connects to the Class 5 PSTN switch via multiple E1/T1 interfaces.

The PSTN Access Gateway can be located at the service providers central office. For example, in the diagram, a subscriber initiates a call through a telephone connected to an IAD/MTA.

The IAD/MTA will connect to the PSTN Access Gateway over the NGA network. The call, including the voice and all related information such as the call's destination, is carried over this connection. To connect between the PSTN switch and the IAD/MTA, the PSTN Access Gateway simultaneously converts the data protocols used by the IAD's/MTA's and NGA equipment, such as IP, Into the V5 protocol used by the voice switch, and vice versa,

A Call Agent is an element Implemented within the Access Gateway. The Call Agent converts the controlling and management signals between the TDM and the IP based standard.

VoIP (Voice over IP) Is a method of transferring Voice over standard IP based infrastructure. IP technology is a common used infrastructure used over internet/intranet networks, enabling a large amount of traffic and services to be transmitted over IP. IP has significant inherent advantages, such as simplicity, IP can be used to transfer high performance services such as voice. In addition, other implemented standard protocols are used to assure Quality of Service (QoS) and security.

Standards available for transferring voice data over IP packets are as follows;

H.323 is a so-called umbrella standard for multimedia communications over local area networks. H.323 belongs to the series of communications standards called H.3x., for multimedia conferencing over different types of networks Including ISDN and PSTN.

Session Initiation Protocol (SIP) is a very simple tea-based application-layer control protocol. It creates, modifies, and terminates sessions with one or more participant. Such sessions include Internet telephony and multimedia conferences. SIP is based on hyper-text markup language (HTML) and is more lightweight than H.323.

MGCP (Media Gateway Control Protocol) is a simple concept based on Text markup language, and is a more recent development which effectively enhances Voice over IP for both cable TV and xDSL.

M.248, also known as Megaco protocol, is considered complementary to H,323 and SIP, in that an Access Gateway control IAD's/MTA's using H.248, but communicate between one or another via H.323 or SIP.

Access networks based on xDSL, cable TV and broadband wireless technologies are referred to as NGA networks. NGA networks enable service providers to offer high-speed data services to small and medium-sized businesses as well as to residential subscribers. However, they were not designed to efficiently carry high-quality voice traffic.

Therefore, it would be desirable to provide an efficient system for transferring and converting voice streams from PSTN into IP packets.

### SUMMARY OF THE INVENTION

Accordingly, it is a principal object of the present invention to provide a voice gateway to deliver Voice over Internet Protocol (VoIP).

It is a further object of the present invention to provide a simple and efficient system for transferring and converting voice streams from the Public Switched Telephone Network (PSTN) into IP packets.

It is a still further object of the present Invention to provide a method for interfacing the PSTN/ISDN access gateway and IP network for entry to the customer premises equipment (CPE) in the form of an Integrated Access Device/Media Terminal Adapter (IAD/MTA), thereby providing both voice PSTN for a plurality Of calls and Integrated Services Digital Network (ISDN) data services.

In accordance with a preferred embodiment of the present invention, there is provided a system to deliver voice over Internet Protocol (VoIP) via an electronic network, utilizing IP packets for transmitting digital data signals, wherein a voice gateway interfaces with: a Public Switched Telephone Network/Integrated Services Digital Network (PSTN/ISDN); a customer premises inter-working (CP-IWF) device via a data port; and customer premises equipment (CPE), and wherein the CP-IWF device serves as a gateway between the digital data signals used in the electronic network and PSTN voice streams. The system includes an access gateway, Including a V5,x device for interfacing the electronic network to the PSTN. The system also includes a voice gateway interfacing with the PSTN to deliver VoIP and a Call Agent to keep track of the calling state between the CP-IWF device and the voice gateway, such that the voice streams are transferred from the PSTN/ISDN and converted into IP packets.

In accordance with a preferred method of the invention there is provided interfacing for a PSTN/ISDN access gateway via a Call Agent to an IP network for entry to the customer premises equipment (CPE) in the form of an Integrated Access Device/Media Terminal Adapter (IAD/MTA), thereby providing both voice PSTN for a plurality of calls and ISDN data services, The method includes the steps of setting a call, allocating of a time-slot for transmission of the call, switching the call, as required, tearing-down the call and de-allocating of the time-slot for the call.

The method combines IP standards and the customization of the V5 standard to create an easily supportable PSTN/ISDN format voice conversion to IP based format.

Call Agent activation keeps track of the calling state between the CPE (IAD/MTA) and the Gateway, thereby ensuring system control and management A local Class 5 switch replacement, Call Agent operates on a packet network to deliver VoIP with the same quality as the PSTN. The Call Agent software acts like a local office “virtual” switch. It supports intelligent call control features and end-to-end signaling for IP gateways using media gateway control protocol (MGCP). The Call Agent also Is transport layer independent. It conducts the set-up and tear-down of a call with “look ahead” capabilities through a Signaling System 7 (SS-7) gateway.

Other features and advantages of the invention will become apparent from the following drawings and description.

### BRIEF DESCRIPTION OF THE DRAWINGS

For a better understanding of the invention with regard to the embodiments thereof, reference is made to the accompanying drawings, in which like numerals designate corresponding elements or sections throughout and in which:

FIG. 1 is a schematic illustration of a prior art telecommunications network,

FIG. 2 is a prior art schematic block diagram of a subscriber initiating a telephone call through an integrated access device (IAD);

FIG. 3 is a schematic block diagram relating to a telephone call made over the IP and interfaced to the TDM, In accordance with the principles of the present invention;

FIG. 4 is a schematic block diagram of the inter-working function (IWF) connections for a PSTN switch and IP network, in accordance with the principles of the present invention; and

Table I is a schematic illustration of a simple MGCP (H,248) call process.

### DETAILED DESCRIPTION OF THE PREFERRED EMBODIMENTS

The invention will now be described In connection with certain preferred embodiments with reference to the following Illustrative figures so that it may be more fully understood. References to like numbers indicate like components in all of the figures.

### The Following are Definition of Terms Used in describing the Invention

ATM: Asynchronous Transfer Mode. A type of protocol for service transfer for fast packet switching that uses a fixed size packet called a cell. This technique makes it possible to transmit data at great speed, and can make voice, multimedia, full-motion video, and video conferencing available to all users, It also makes dynamic allocation of bandwidth possible; telephone and cable TV companies can charge individual customers based on the amount of bandwidth they use. ATM is the standard used by telecommunications company backbones

CLASS 5 SWITCH; A class 5 switch is the workhorse of today's telephone network. One of these switches, which are analogous to a large mainframe computer, sits in every Central Office of a telephone network and there are thousands of those in the U.S. Every ordinary voice telephone call goes through a Class 5 swich, which handles the voice signal according to pre-defined parameters, The switches that long-distance companies put In each metro area to connect to the local phone networks were known as Class 4 switches. The Class 5 switch is a circuit switch, switching voice calls on a per-circult basis, but doing so less efficiently in use of bandwidth than a packet switch, which combines all Incoming packets into the available bandwidth to “stuff” transport pipes as full as possible;

CPE: Customer Premises Equipment;

E1: Wide-area digital transmission scheme used predominantly In Europe that carries data at a rate of 2.048 Mbps. E1 lines can be leased for private use from common carriers;

IAD: Integrated Access Device, An IAD sits at the customer premises and provides an interface to the network, receives the packetized voice from the Incoming broadband network and converts it to analog signals for use by the telephone;

IP: Internet Protocol. A protocol for service transfer in which data is sent In variable length packets, containing a header with addressing, type of service specification, fragmentation and reassembly parameters and security information. IP is the protocol used by the Internet and most computers for data communications;

ISDN: Integrated Services Digital Network, Communication protocol, offered by telephone companies, that permits telephone networks to carry data, voice, and other source traffic;

IWF: Inter-working Function. To make circuits-switched data work, the carrier must provide a customer premises (CP-IWF) at the switching center that serves as a gateway between the digital data signals used in the cellular network and other networks such as the public telephone network. Traditionally the IWF has consisted of modem pools to allow modem-based communication across the telephone network. Modem pools allow users to make calls to Internet service providers, online service providers such as AOL™ and modems or standard fax machines at corporate and other sites. The combination of cellular phone and cellular network is like a serial cable extension cord to the modems at the inter-working function, Another type of IWF is a central office-based (CO-IWF) that connects users directly to the Internet where the Internet access is provided by the carrier Itself, or is handed over automatically via digital-trunked lines to an Internet service provider (ISP);

MGCP: Media Gateway Control Protocol. MGCP is a VoIP Internal protocol used within a distributed system that appears to the outside world as a single VoIP gateway. This system is composed of a Call Agent, and a set of gateways, including at least one “media gateway” that performs the conversion of media signals between circuits and packets, and at least one “signaling gateway” when connected to an SS7 controlled network; MTA: Media Terminal Adapter or IAD, which sits at the customer premises and provides an Interface to the network, receives the packetized voice from the incoming broadband network and converts it to analog signals for use by the telephone;

PCM: Pulse Code Modulation. PCM is a digital scheme for transmitting analog data, The signals in PCM are binary; that is, there are only two possible states, represented by logic j (high) and logic o (low). This is true no matter how complex the analog waveform happens to be, Using PCM, it is possible to digitize all forms of analog data, including full-motion video, voices, music, telemetry, and virtual reality (VR);

POTS: Plain Old Telephone System;

PSTN: Public Switched Telephone Network. The collection of interconnected systems operated by the various telephone companies and administrations (telcos and Public Telephone & Telegraph's) around the world;

T1: Digital WAN carrier facility. T1 transmits DS-1-formatted data at 1.544 Mbps through the telephone-switching network;

TDM: Time Division Multiplexer. A type of multiplexer where two or more channels of information are transmitted over the same link by allocating a different time Interval (“slot” or “slice”) for the transmission of each channel. I.e., the channels take turns using the link. Some kind of periodic synchronizing signal or distinguishing identifier is usually required so that the receiver can tell which channel is which, TDM becomes Inefficient when traffic is intermittent because the time slot is still allocated even when the channel has no data to transmit; and VoIP; Voice over IP, The ability to carry normal telephony-style voice over an IP-based Internet with POTS-like (plain old telephone service) functionality, reliability, and voice quality. Voice over IP enables a router to carry voice traffic (for example, telephone calls and faxes) over an IP network. In Voice over IP, the digital signal processor (DSP) segments the voice signal into frames, which are then coupled in groups of two and stored in voice packets,

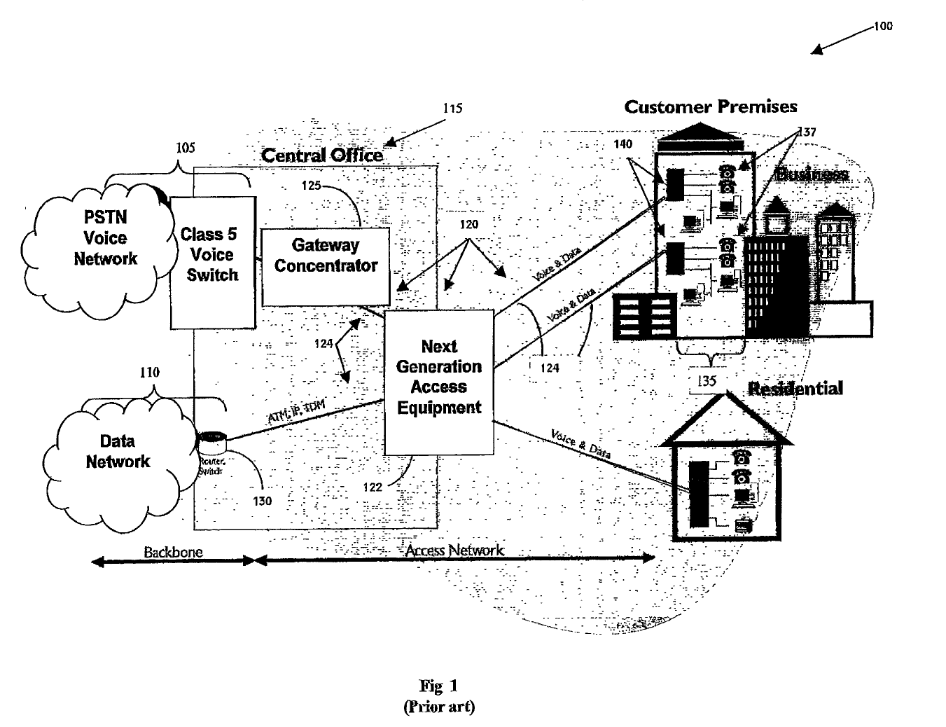

Reference is now made to prior art FIG. 1, which is a schematic illustration of a prior art telecommunications network. Traditionally, two separate backbones carried voice and data traffic: a public switched telephone network (PSTN) backbone 106 carried voice and an IP packet-based data network 110 or backbone carried data. A central office 115 connects backbone networks 105 and 110 to an access network 120. Central office 115 hosts a voice switch 125 that switches incoming and outgoing voice calls to their ultimate destination, and hosts routers and data switches 130 that handle data traffic. Service providers using class 5 switches, a type of voice switch typically installed at central offices, offer their customers a variety of value-added services, such as call forwarding, call waiting and caller identification

Access network 120 comprises access lines 124 and equipment 122 connecting service providers' central office 115 to customer premises equipment (CPE) 135 and Integrated Access Devices (IAD's) /Media Terminal Adapters (MTAs) 140, which conned several OPE's 137,

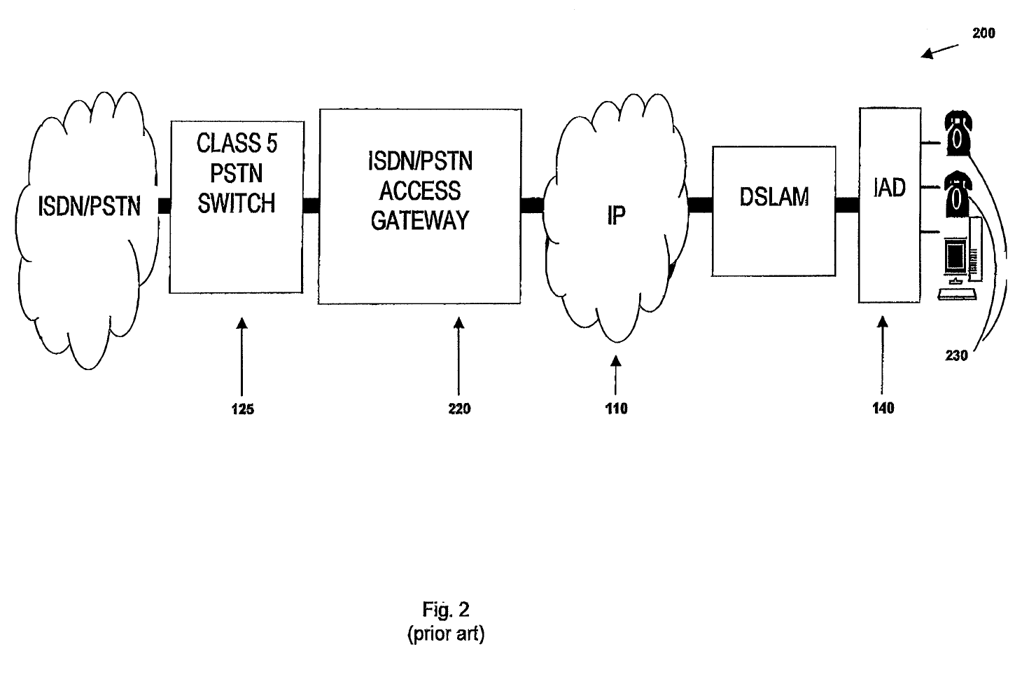

FIG. 2 is a prior art schematic block diagram of a subscriber Initiating a telephone call through integrated access device (IAD) 140. The PSTN Access Gateway 220 serves as the bridge between the circuit-based voice switch, i.e. class 5 PSTN switch 126 and IP packet-based data network 110. It receives voice traffic in an IP packet format converts to standard time division multiplexing (TDM) pulse-coded modulation PCM format, and connects to Class 5 PSTN switch 125 via multiple E1/T1 Interfaces 220.

PSTN Access Gateway 220 can be located at the service provider's central office, For example, in FIG. 2, a subscriber initiates a call through one of the telephones 230 connected to IAD/MTA 140.

IAD/MTA 140 connects to PSTN Access Gateway 220 over the NGA network. The call, including the voice and all related information such as the call's destination, is carried over this connection, To connect between the PSTN switch 125 and IDA/MTA 140, PSTN Access Gateway 210 simultaneously converts the data protocols used by IAD's/MTA's 140 and NGA equipment, such as IP, into the V5 protocol used by the voice switch 125, and vice versa.

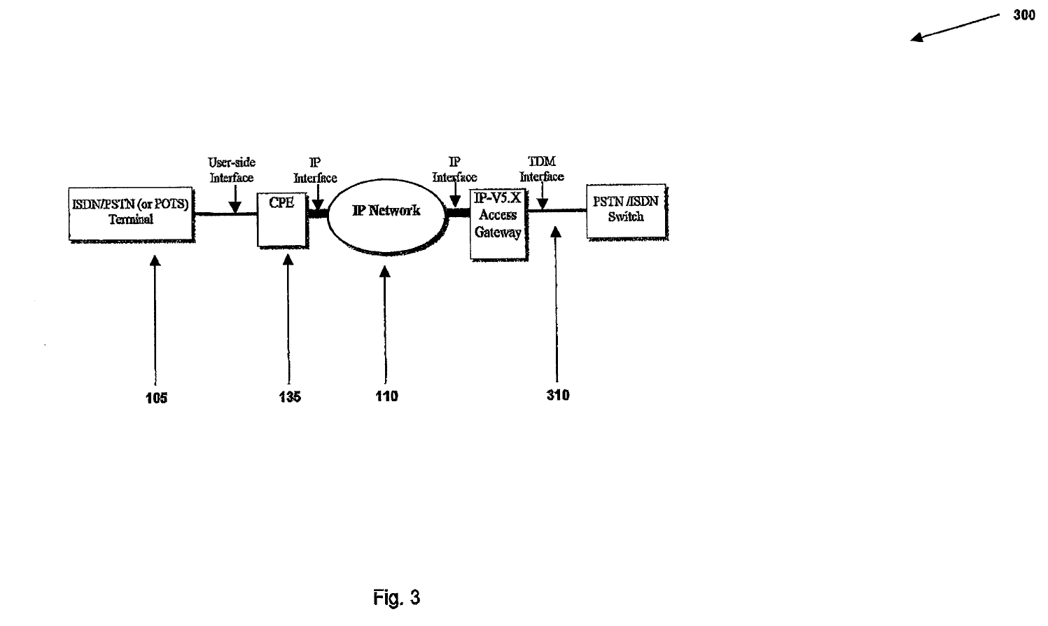

FIG. 3 is a schematic block diagram relating to a telephone call 300 made over IP packet-based data network 110 and Interfaced by TDM 310, in accordance with the principles of the present invention. Customer Premises Equipment (CPE) 135 is interfacing both PSTN/ISDN 105 and IP data network 110, The central office-based inter-working function (CO-IWF) provides access for multiplexed IP connections to the TDM world. CO-IWF connects users directly to the Internet where the Internet access is provided by the carrier itself, or is handed over automatically via digital-trunked lines to an Internet service provider (ISP).

All Interfaces are based on IETF, International Telecommunications Union (ITU), European Telecommunications Standards Institute (ETSI) and asynchronous transfer mode (ATM) Forum standards, and incorporate proprietary solutions for parts of the interface functionality.

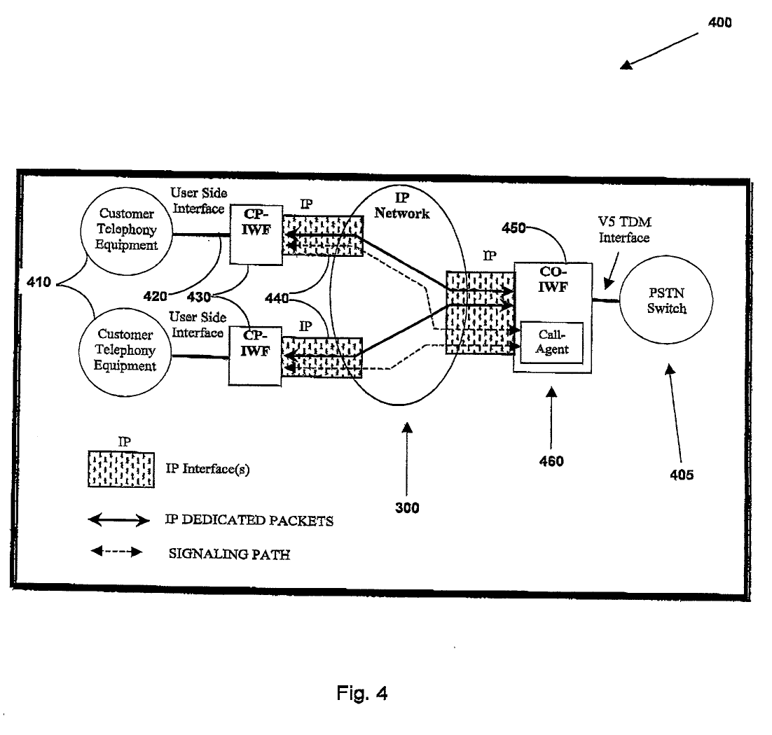

FIG. 4 is a schematic block diagram of the inter-working function (IWF) connections module 400 for a PSTN switch 405 and IP network 10, in accordance with the principles of the present invention.

The customer telephony equipment 410 comprises PSTN/POTS modules, which can be a POTS/ISDN telephone, modem or fax machine.

The Customer Premises-Inter-Working Function (CP-IWF) 430 depends on the Next Generation Access (NGA) platform used. It can be a cable modem access box, i.e. a set-top box, interfacing the (1) TV set, (2) PSTN/ISDN and (3) Data port on the user-side Interface 420 side, and an IP interface 440 on the other side,

IP Network 110 can be an IP based Intranet/Internet network, the network interface between different elements. The transport rate can range from 10 Mbit to 1000 Mbit or more. CO-IWF 450 includes the Next Generation Access (NGA) and the Access Gateway. The NGA interfaces CP-IWF 450 via the media platform, for example, a cable modem on one side, and the Access Gateway on the other, using an IP/ATM based platform.

The access gateway includes the Voice Engine Implementation and the Call Agent 480, The role of the Voice Engine is to process the incoming and outgoing call between the two worlds, PSTN/ISDN 405 and IP 110.

The role of the Call Agent 460 is to control the signal translation between the two worlds, PSTN/ISDN and IP, manage the CPE's and communicate with other similar platforms.

### Some Additional Functionalities, with Added Values, are Supported

Quality of Service (QoS)—standard protocols supported by all elements including CPE, NGA and Access Gateway is needed in order to provide a high quality service;

The access Gateway is capable of supporting QoS protocols such as Resource ReSerVation Protocol (RSVP);

Security—standard protocols supported by all elements including CPE, NGA and Access Gateway is needed in order to provide a secured service;

The access Gateway is capable of supporting security protocols such as IPSec and Domain Name Server (DNS); and

Bandwidth savings several standards are popular to support compression of packets in order to save network bandwidth. All elements including the CPE, NGA and Access Gateway shell support those codes. Access Gateway is capable of supporting compression standards, such as G.729x,

System Requirements: Both CPE and CO-IWF components provide a complete solution for transferring Voice over IP services:

From the user side, each CPE device should be capable of interfacing PSTN/POTS normally using a RJ11 connector. It shall also support all relevant protocols for transferring Voice over IP; and

From the CO-IWF side, each NGA device should be capable if interfacing the access Gateway using standard media protocols as 100Bt Ethernet;

### Relevant Standards

PacketCable—Security: PKT-SP-SEC-102-001229

PacketCable—Network-Based Call Signaling Protocol Specification:

PKT-SP-EC-MGCP-102-991201;

PacketCable- Dynamic Quality-of-Service: PKT-SP-DQOS-102-00018;

ITU-T H.248: MEGACO;

ITU-T H.323;

IETF-RFC2705: MGCP:

IET-RFC2401; Security Architecture for the Internal Protocol;

IETF-RFC1889: RTP—A Transport Protocol for Real-Time Applications;

IETF-RFC2205: Resource ReSerVation Protocol (RSVP); and

IETF-RFC2543: SIP Session Initiation Protocol.

The configuration of CP-IWF 430 depends on the Next Generation Access (NGA) platform used. It can be a cable modem access box, i.e. a set-top box, interfacing the (1) TV set, (2) PSTN/ISDN and (3) Data port on the user-side interface 420 side, and an IP interface 440 on the other side, which further interfaces with CO-IWF 450 and Call Agent 460 as shown by the arrangement of double-headed arrows.

Call Agent 460 activation keeps track of the calling state between the CPE (IAD/MTA) and the Gateway. thereby ensuring system control and management. A local Class 5 switch replacement, Call Agent operates on a packet network to deliver VoIP with the same quality as the PSTN, The Call Agent software acts like a local office “virtual” switch. It supports intelligent call control features and end-to-end signaling for IP gateways using media gateway control protocol (MGCP), Call Agent 480 also is transport layer independent. It conducts the set-up and tear-down of a call with “look ahead” capabilities through a Signaling System 7(SS-7) gateway.

The details of the operation of connections module 400 are illustrated in TABLE I.

Table I is a schematic illustration of a simple MGCP (h.248) call process:

TABLE I

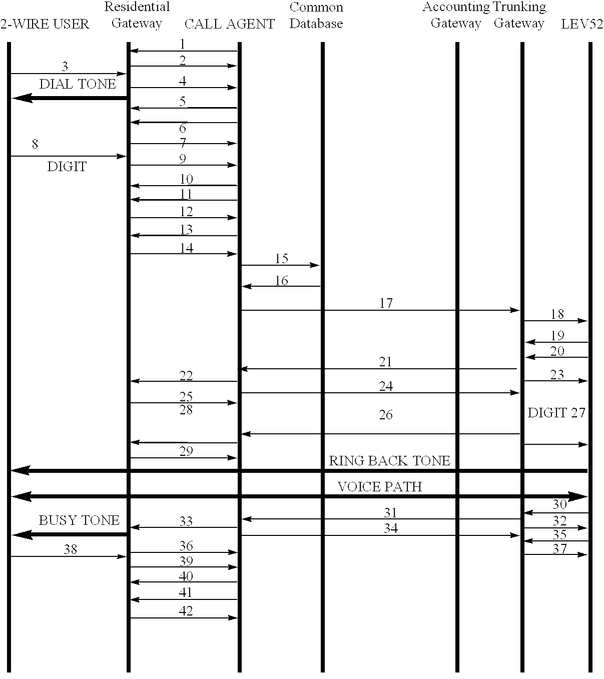

### Events Description for Table I:

Two Gateways are involved: residential and trunking, in addition, the common database is shown and an accounting Gateway. The following is a description of the sequence of events:

Event 1: The NotificationRequest command must be sent to the residential Gateway before the Gateway can handle a connection. Be aware that this command is not a crafting (configuration) command. The Call Agents and Gateways must be preconfigured. Assume that this command is directing the Gateway to monitor for an offhook condition on a specific endpoint connection.

Event 2: The Gateway acknowledges the command. It uses the same transaction number that was in the command in event 1.

Event 3: Thereafter, the Gateway monitors for this transition, and eventually the user goes offhook to make a call,

Event 4: The Gateway sends a Notify to the Call Agent, with the message coded to show the offhook event for the monitored endpoint.

Event 5: The Call Agent must acknowledge the Gateway's transmission.

Event 6: The Call Agent's decisions on what to tell the Gateway next preferably depends on the type of line being monitored, Assuming it is a conventional dialup (nondirect) line, it sends a NotificationRequest command directing the Gateway to play a dialtone, and to collect digits.

Event 7: The Gateway responds with an acknowledgment (ACK), and gives dialtone to the user, The exact sequences of these two events vary, depending on the specific implementation,

Event 8: Based on the digit map sent to it in event 7, the Gateway accumulates digits.

Event 9: Also based on the digit map of event 7, the Gateway notifies the Call Agent with a message containing an ObservedEvent parameter. This parameter contains the collected digits,

Event 10. The Call Agent ACK's the message.

Event 11: Next, the Call Agent sends a NotificationRequest command to direct the Gateway to stop collecting digits, and to monitor for an onhook transition.

Event 12: The Gateway ACKs the command.

Event 13: The CreateConnection command is sent by the Call Agent to seize the incoming circuit. This message contains the CallId, LocalConnectionOption, and the ConnectionMode parameters. The LocalConnectionOptions are; (a)—packetization period In milliseconds; (b)—compression algorithm (G.711, G.723, etc.); (c)—bandwidth for the connection; and (d) user of nonuse of echo cancellation The ConnectionMode is set to receive only. {please clarify}

Event 14: The Gateway ACKs the command. In this message the new connection (ConnectionID) is identified, as is the session description (an SDP announcement) that is used to receive the audio traffic. This description may contain the IP address at which the Gateway is ready to receive the audio data, the protocol used to transport the packets (RTP), the RTP port (3456) and the audio profile (AVP), in accordance with RFC 1890. The AVP defines the payload type, such as G.711. This message can also be used to inform the Call Agent that the Gateway is ready to use other audio profiles. For example, G.726 for 32 kbit/s ADPCM may also be stipulated.

event 15: The Call Agent now must determine where to route the call and to which egress Gateway the connection should be established. It sends a query to the common database to obtain this information.

Event 16:, The needed information is returned to the Call Agent, 9 Event 17: The Call Agent has sufficient information to send a CreateConnection command to the egress Gateway, in this example, a V5.2 trunking Gateway. The parameters in this message mirror the parameters exchanged in events 13 & 14 between the residential Gateway and the Call Agent and the session description in this message is the same as the description given to the Call Agent by the residential Gateway. There are two differences: (a)—the EndPointId identifies the endpoint at the outgoing at the trunking Gateway; and (b)—the mode parameter is set to send/receive. The Called is the same in this message since the two endpoint connections belong to the same call.

Event 18; The V5,2 trunking Gateway is sent to V5.2 Local Exchange LE message ESTB[OffHook].

Event 19; The V5.2 Local Exchange LE returns to V5.2 trunking Gateway message ESTBACK.

Event 20: The V5.2 Local Exchange LE is sent to V5,2 trunking Gateway message ALLOC,

Event 21: The V5.2 trunking Gateway responds with an ACK, in this message is this Gateway 's session description such as its IP address, Its port and its RTP profile.

Event 22: The information obtained in event 21 is used to create the ModifyConnection command that is sent to the residential Gateway. The parameters in this command reflect the parameters in the ACK in event 21,

Event 23: The V5.2 trunking Gateway is sent to V5.2 Local Exchange LE massage ALLOCCMPL.

Event 24: The Call Agent has sufficient information to send a ModifyConnection command with Digit Map parameters (PSTN/ISDN destination DN) to V5.2 trunking Gateway.

Event 25: RGW return the ACK message (in event 22).

Event 26: V5.2 TGW return the ACK message (in event 24).

Event 27: The V5.2 TGW send DIGIT (destination DN) to V5.2 LE. The V5.2 TGW generates Dual Tone Multi Frequency (DTMF) or uses a V6.2 message.

Event 28: The Call Agent sends a NotificationRequest command to the Residential Gateway to instruct It to remove the dial tone from the line.

Event 29: The Gateway removes the dial tone and ACKs the command.

After this point, the connection has been in a Pull Duplex mode.

{Please Clarify}

Disconnect Scenario

Event 30: When PSTN subscriber does a close call, V5.2 Local Exchange send to V5,2 trunking Gateway V5.2 message DeALLOC.

Event 31: The V5.2 TGW send a DeleteConnection command to Call Agent This message contains the respective EndPointID and ConnectionID.

Event 32: The V5.2 TGW return (in event 30) V5.2 message DeALLOCCMPL

Event 33: The Call Agents send a DeleteConnection command to RGW. RGW receive this message and generate BUSY TONE.

Event 34: The Call Agent sends ACK command to V5.2 TGW (in event 31).

Event 35: The V5.2 LE sends DISCONECT to V5.2 TGW.

Event 36: The RGW sends ACK command to Call Agent (in event 33).

Event 37: The V5.2 TGW sends to V5.2 LE DISCONECT CMPL.

Event 38: The RGW subscriber sends ONHOOK to RGW.

Event 39: The ONHOOK event is relayed to the Call Agent with a Notify message.

Event 40: The Call Agent ACKs the message.

Event 41: The Call Agent then “resets” the endpoint by informing the RGW to monitor for an OFFHOOK condition.

Event 42: The RGW ACKs the command.

In summary, the present invention provides a voice gateway to deliver Voice over internet Protocol (VoIP), using a simple and efficient system for transferring and converting voice streams from the Public Switched Telephone Network (PSTN) into IP packets. The invention also provides a method for interfacing the PSTN/ISDN access gateway and IP network for entry to the customer premises equipment (CPE) in the form of an Integrated Access Device/Media Terminal Adapter (IDAS/MTA), thereby providing both voice PSTN for a plurality of calls and Integrated Services Digital Network (ISDN) data services.

Having described the present invention with regard to certain specific embodiments thereof, it is to be understood that the description is not meant as a limitation, since further modifications may now suggest themselves to those skilled in the art, and It is intended to cover such modifications as fall within the scope of the appended claims.

I claim:

1. A system to deliver voice over Internet Protocol (VoIP) via an electronic network, utilizing IP packets for transmitting digital data signals, wherein a voice gateway interfaces with a Public Switched Telephone Network/Integrated Services Digital Network (PSTN/ISDN) with a customer premises inter-working (CP-IWF) device via a data port and with customer premises equipment (CPE), and wherein the CP-IWF device serves as a gateway between the digital data signals used in the electronic network and PSTN voice streams, said system comprising:
an access gateway, including a V5.x device for interfacing the electronic network to the PSTN:
a voice gateway interfacing with the PSTN to deliver VoIP; and
a Call Agent to keep track of the calling state between the CP-IWF device and said voice gateway,
such that the voice streams are transferred from the PSTN/ISDN and converted into IP packets.

2. The system according to claim 1, further comprising a central office-based inter-working function (CO-IWF) that connects said CPE directly to said electronic network.

3. The system according to claim 2, wherein said CO-IWF comprises access gateway, and further comprises Next Generation Access (NGA).

4. The system according to claim 1, wherein the V6.x device enables a variety of value added services.

5. The system according to claim 1, wherein said access gateway connects to said V5.x device via a plurality of E1/T1 interfaces.

6. The system according to claim 1, wherein said access gateway is located at the central offices of a service provider.

7. The system according to claim 1, wherein said access gateway further comprises a voice engine for processing calls between the PSTN/ISDN and the electronic network.

8. The system according to claim 1, wherein said access gateway includes said Call Agent.

9. The system according to claim 1, wherein said access gateway supports Resource ReSerVation Protocol (RSVP).

10. The system according to claim 1, wherein said access gateway supports IPSec.

11. The system according to claim 1, wherein said access gateway supports Domain Server Name (DSN).

12. The system according to claim 1, wherein said access gateway supports G.729x compression standards.

13. The system according to claim 1, wherein said electronic network is the Internet.

14. The system according to claim 6, wherein access to said Internet is handed over automatically via digital-trunked lines to an Internet service provider.

15. The system according to claim 6, wherein access to said Internet is provided by the PSTN.

16. The system according to claim 1, wherein said electronic network is an Intranet.

17. The system according to claim 1, wherein the CP-IWF device comprises a cable modem access box.

18. The system according to claim 1, wherein the CP-IWF device comprises a set-top box for interfacing a TV set, the PSTN/ISDN and the data port.

19.The system according to claim 1, wherein the system supports standard protocols relating to at least one of quality of service (QOS) and security.

20. A method to provide interfacing for a PSTN/ISDN access gateway via a Call Agent to an IP network for entry to the customer premises equipment (CPE) Integrated Access Device/Media Terminal Adapter (IAD/MTA), providing both PSTN for a plurality of calls and ISDN services, said method comprising
setting-up a call;
allocating of a time-slot or transmission of said call;
switching said call as required;
tearing-down said call; and
de-allocating of said time-slot for sad call.
